(19) United States
(12) Patent Application Publication
(10) Pub. No.: US 2002/0046187 A1
(43) Pub. Date: Apr. 18, 2002

(54) Automated system for initiating and managing mergers and acquisitions

(76) Inventors: Frank Vargas, Long Lake, MN (US); Stan Tenenbaum, Maple Grove, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 09/824,611

(22) Filed: Apr. 2, 2001

Related U.S. Application Data
(60) Provisional application No. 60/193,758, filed on Mar. 31, 2000.

(51) Int. Cl. G06F 17/60

(52) U.S. Cl. 705/67

(57) ABSTRACT

An automated system utilizes a networked computer system such as the Internet for initiating and managing mergers and acquisitions of businesses between third parties. A host computer system connected to the network hosts a site operated on behalf of an investment banking firm. The site includes a secured login area, a seller registration area, a buyer registration area, a unique home page area for each registered seller and registered buyer, and a secure administration area. In each registration area a user enters profile information and is registered as a registered seller or registered buyer. The registered seller also provides detailed confidential information about a business to be offered for sale in addition to the seller profile. The unique home page area displays information and communications relating to opportunities matching the profile for that registered seller or buyer. In the secure administration area, a user for the investment banking firm tracks the initiation and management of matching opportunities and information, history, status and communications among registered sellers and registered buyers. A management program executes on the host computer and interfaces with the site to coordinate communications among registered sellers, registered buyers and the investment banking firm in response to actions at the site. The automated system allows registered sellers to selectively control the transmission of confidential information of the registered seller to potential registered buyers and allows registered buyers to generate expressions of interest and offers for the businesses of registered sellers using the site as the communication medium for such actions.

### FIELD OF THE INVENTION

The present invention relates generally to the field of automated electronic business and financial practices and management. More specifically, the present invention relates to an automated system for initiating and managing mergers and acquisitions of businesses utilizing the Internet.

### BACKGROUND OF THE INVENTION

The growth of the computerized networks such as the Internet has presented many opportunities for improving the way in which business and financial practices are conducted. The automated matching of buyers and sellers using a computerized network, for example, is the subject of numerous patents. Examples of these patents include patents related to automated auctions such as U.S. Pat. Nos. 4,992,940, 5,905,975, 5,794,207, 5,966,699 and 5,995,947; patents related to matching real estate buyers and sellers such as U.S. Pat.Nos. 5,500,793, 5,664,115 and 5,754850; and patents related to matching buyers and sellers of stocks, bonds, currencies and other financial instruments such as U.S. Pat. Nos. 3,573,747, 5,724,524, 5,864,827 and 5,913,202.

Recently, a few Internet sites have focused on matching buyers and sellers of businesses. Generally, these sites operate as electronic classified advertisements, describing businesses and companies that are available for sale, merger or acquisition to potential buyers. Like most other matching systems that utilize a computer network, the primary purpose of these sites is to provide an initial contact between buyers and sellers.

The web site bizsale.com allows sellers of businesses to register online and provide detailed information about the business being sold. The web site lists these businesses by location and category for review by potential buyers. To become a potential buyer, a buyer must complete and sign a buyer registration form that includes location and category preferences, as well as price range preference. The form specifies how the buyer would like to be contacted by sellers, and includes an authorization for financial verification, a nondisclosure agreement, and an obligation of the buyer to inform the web site in the event that a deal is concluded. The buyer faxes the completed form to the web site and the web site notifies the buyer whether the buyer has been accepted. Once accepted, a potential buyer can browse the seller listings, and the web site makes available a list of opportunities that match the buyer's areas of interest. This web site is strictly an advertising service and does not act as a broker or agent for either the buyer or the seller, or otherwise facilitate the consummation of a transaction.

The web site cbex.com is another site that matches buyers and sellers of companies. Users must register with the site and provide the email addresses of three acquaintances interested in receiving information on the purchase or sale of companies. In exchange for these contacts, the site allows users at no cost to browse through the lists of available companies and purchasers and sign up for mailing lists about potential opportunities based on their preferences. The site also makes available a listings-management feature that operates like a contact management software program to assist users in keeping track of fax contacts initiated by the user with potential buyers or sellers. For a fee, the site has available certain marketing services, such as business valuation, business plan writing and buyer finder services. The buyer finder services consist of assistance in preparing and marketing company that culminates in the delivery to the seller of a list of buyer prospects who have signed nondisclosure agreements. The services do not extend, however, into the negotiation, facilitation or consummation of transactions.

The web site nationalacquisition.com is another similar site. A business owner/seller completes a questionnaire and writes a brief description of their company. The description is non-confidential and does not identify their company, nor is direct contact information included. Buyers also complete a questionnaire and an application which includes a statement that they are reviewing any company information on their own behalf, that they have the financial ability to complete the transaction, and that they are not acting as an agent or broker. On a weekly basis, the companies are automatically matched with the stated investment criteria of the buyers. Buyers are presented with the in-the-blind descriptions of those companies that match their criteria. The buyers do not have to visit the site, or visit a password protected area of the site to screen companies themselves; instead the web site does the screening for the buyers. If a buyer wants further information, the owner/seller of that company is notified of the buyer's interest and name. If the owner/seller wishes to proceed and be introduced, the buyer is given the identity and contact information of the owner/seller. Further discussions and contact are up to the principals.

The web site emergers.com also lists sale and acquisition opportunities. Unlike the sites just described, this site does not serve as a third party matching interested buyers and sellers. Instead, users select opportunities of interest based on their online review of short non-confidential summaries of opportunities presented on the site. Preferably, there is a defined agent-like relationship where either a buyer or a seller retains the investment banking firm which owns the site or another participating investment bank affiliated with site, with that client being responsible for the fees of the investment bank. Also unlike the sites just described, this site does not require users to register before information about opportunities is presented. Instead, all of the information available on the site is presented in a non-confidential format until such time as the user executes a confidentiality agreement for a particular opportunity that may be of interest.

In the context of a sales opportunity, the emergers.com investment bank would conduct a thorough due diligence review of the business, prepare a selling memorandum, identify and contact on a confidential basis potential buyers, and structure, negotiate, document and close the sale. Potential buyers who learn about a particular sale on the web site are presented with a brief non-confidential recap of the opportunity and the present status of the transaction. The present status of the transaction consist of a series of icons that are marked to indicate whether the opportunity has been exclusively retained by an investment bank, whether a descriptive memorandum has been prepared, whether initial offers have been received, whether a definitive agreement has been signed, and whether the transaction is completed. By clicking on “Summary Description,” the potential buyer can review a more complete non-confidential summary of the opportunity which are meant to provide sufficient information to interested parties while minimizing the ability of parties to specifically identify the candidate. By clicking on “Confidentiality Agreement,” the user can receive the agreement that will be required prior to receipt of a confidential descriptive memorandum. The user can choose to receive this confidentiality agreement online in PDF format, via e-mail, or by fax. In order to receive more detailed information regarding an exclusive sale opportunity, interested parties must execute a confidentiality agreement and return it to the site by fax. Interested parties must also receive client approval, and to do so must provide certain information regarding their background, financial capability and strategic interest in the transaction. This information can also be provided online for each opportunity. By clicking “Express Interest,” the user can provide information regarding interest in the opportunity and submit questions the user may have about the opportunity. All inquiries about an opportunity are directed through the site, and interested parties are instructed not make any attempt to contact any listed company directly. Once a party has expressed an interest, however, negotiations and other actions relative to consummating a deal are made over conventional communications channels.

In the context of an acquisition opportunity, the emergers.com investment bank would assist in focusing strategic acquisition criteria, identify and approach acquisition opportunities known to the investment bank or to the buyer, conduct a thorough due diligence analysis and valuation of prospective acquisition candidates, and structure negotiate, document and where appropriate arrange financing for the acquisition. Users of the site who have knowledge of a potential acquisition can select a particular acquisition mandate, and are presented with a recap of the opportunities being sought. By then clicking on “Acquisition Criteria,” the user can review a more complete non-confidential summary of the company's specific criteria and capabilities. By clicking on “Propose Acquisition Candidates,” the user can provide information regarding potential candidates. No brokers or finder's fees are provided for in this arrangement.

The web site capital.com provides a variety of financial products for commercial financial customers. The site has online forms that may be completed to apply for loans and other financial products. There is also an automated valuation program that determines the value of a company based on certain valuation models. The site also provides downloadable sample forms that can be used in the sale of a business, such as confidentiality agreements and letters of intent. The site specifically notes that these forms are only examples. Prospective sellers of a business are directed to contact the operators of the site by telephone or e-mail if they are interested in selling their business and the process would then proceed in a conventional manner.

Other web sites such as garage.com, nvst.com, vcapital.com, angeltips.com offroadcapital.com, businessangels.com.au, and esource.svb.com are designed to match entrepreneurs and start-up companies with venture capital funds, investment angels and other sources of investment. While this type of investment financing involves business financial arrangements, the process is different than the process of arranging for merger and acquisition opportunities. Typically, one or a small group of investors collaborate to fund the capital needs of an entrepreneur or organization in exchange for some kind of equity position or financial instrument. As such, the investment financing process does not have the same kind of “multi-party” bidding and time-critical events as are present in a properly managed merger or acquisition process and the process of funding entrepreneurs or start-up companies is substantially different than the merger or acquisition process.

Still other web sites such as e-loan.com, lendingtree.com, link2loans.com, loan.yahoo.com, getsmart.com, and 4-credit-loans.com are designed to match individuals with mortgage, credit card and car loan lenders. These sites are directed to retail financial consumers. Most of these sites are organized to give the consumer one or more competitive bids for loans based on a one-time submission of a completed standardized application form. The web site lendersinteractive.com operates as an independent search engine to search for lenders that match criteria supplied by a retail financial customer so as to generate a series of referrals to various lenders that a user can then contact. Because these sites are geared toward retail financial customers, they are not capable of addressing the complexities or needs of business financial transactions.

U.S. Pat. No. 5,924,082, entitled “Negotiated Matching System” and issued to Reuters Corp., describes a matching system for financial trading transactions based on trading information and ranking information of buyers and sellers that can accommodate nonstandard trading transactions. Once a match is identified by the system, the system indicates to the traders accessing the system that a transaction is “pending.” While the transaction is pending, the buyer and seller use the system to transmit negotiating messages to negotiate some or all of the nonstandard terms of the transaction. The particular context in which the system is used is the trading of financial instruments by banks and other financial institutions where each party to a potential transaction may wish to use its own set of criteria to evaluate details of the proposed transaction or to negotiate unique terms for the transaction. The system operates as an electronic financial clearinghouse for the transaction having the ability to temporarily suspend execution of the transaction pending negotiation of these nonstandard terms by the parties.

While the idea of using the Internet to assist in matching buyers and sellers of businesses is known, the process initiating and managing such transactions continues to be accomplished in much the same way that it always has been. Although one investment bank has begun to use a web site for certain parts of the process of consummating a merger or acquisition, this web site is used more as another communication tool for disseminating information about potential opportunities to wide audience of unscreened and mostly unsuitable users of the Internet. It would be advantageous to provide for a system for managing mergers and acquisitions of businesses between third parties utilizing the Internet that capitalized on the ability of a computerized network to control each step of the process so as to enhance the management and effectiveness of the merger and acquisition process as compared to the conventional way in which these transactions have been accomplished.

### SUMMARY OF THE INVENTION

The present invention is an automated system for initiating and managing mergers and acquisitions of businesses between third parties utilizing a networked computer system such as the Internet. A host computer system is operably connected to the networked computer system and hosts a site operated on behalf of an investment banking firm. The site includes a secured login area, a seller registration area, a buyer registration area, a unique home page area for each registered seller and registered buyer, and a secure administration area. In each registration area a user enters profile information and is registered as a registered seller or registered buyer. The registered seller also provides detailed confidential information about a business to be offered for sale in addition to the seller profile. The unique home page area displays information, history, status and communications relating to opportunities matching the profile for that registered seller or buyer. In the secure administration area, a user for the investment banking firm tracks the initiation and management of matching opportunities and information and communications among registered sellers and registered buyers. A management program executes on the host computer and interfaces with the site to coordinate communications among registered sellers, registered buyers and the investment banking firm in response to actions at the site via the networked computer system. The automated system allows registered sellers to selectively control the transmission of confidential information of the registered seller to potential registered buyers and allows registered buyers to generate expressions of interest and offers for the businesses of registered sellers using the site as the communication medium for such actions.

### BRIEF DESCRIPTION OF THE DRAWINGS

FIG. 1 is is a block diagram of a typical network environment for the present invention.

FIG. 2 is an overall block diagram of a site in accordance with the present invention.

FIGS. 3-14 are screen shots of various pages of a site in accordance with present invention.

FIG. 15 is a block diagram of a preferred embodiment of the management program in accordance with the present invention.

### DETAILED DESCRIPTION OF THE PREFERRED EMBODIMENT

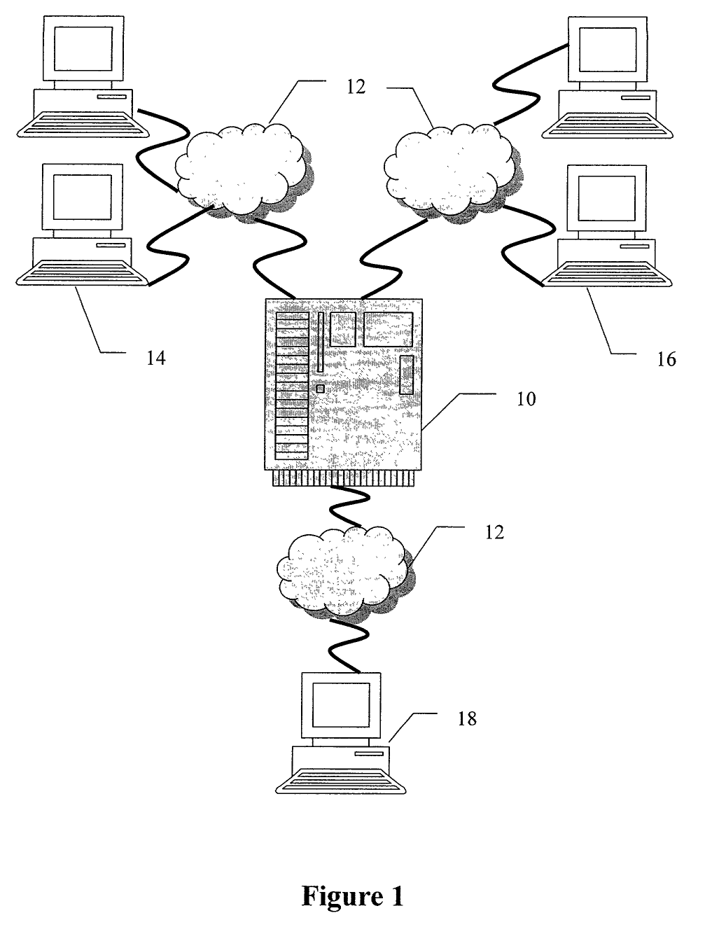

Referring to FIG. 1, a typical network environment for the present invention is shown. A host computer or server 10 is connected to a network 12, such as the Internet, that is accessible to computer systems of independent third parties, such as sellers 14 and buyers 16. The server 10 is also accessible via the network 12 by a computer for a user 18 for the investment banking firm. The server 10 hosts a site on behalf of the investment banking firm as will be described. The server 10 and network 12 can be implemented using products and services from any number of commercially available computer and networking providers. Although the preferred embodiment of the present invention will be described in reference to the current embodiment of the Internet, the present invention is equally applicable to future embodiments of the Internet and to other computer networked environments in which computer systems for unrelated third parties have the ability to communicate across the networked environment.

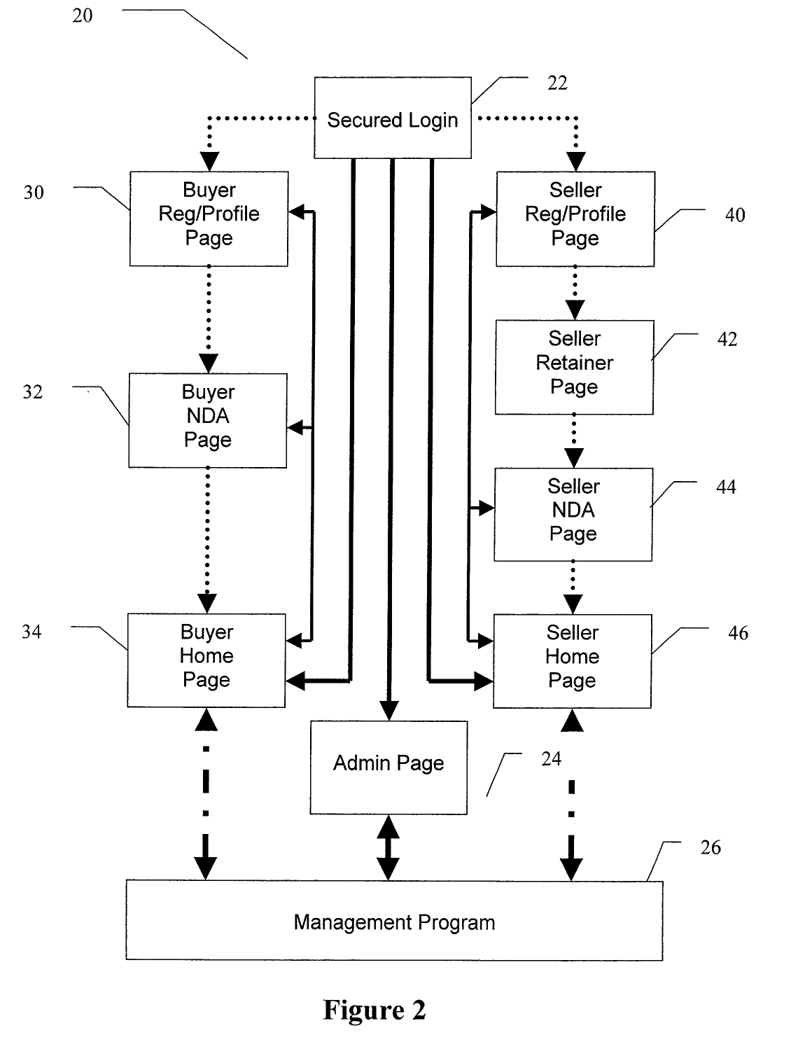

FIG. 2 shows an overall block diagram of a site 20 hosted on the server 10. A user logs into site 20 at a secured login 22. Separate secured login's may be provided for sellers, buyers and administrators; or a single login can be provided for all users. Various types of secured logins may be used, but preferably a user ID and an associated password are required to access site 20. Once a user has logged into site 20, the user is directed to the appropriate pages for a seller, a buyer or administrator. If the user is an administrator, the user goes to administrator page 24 as will be described. If the user is a buyer, the user is directed initially to a buyer registration/profile page 30. In one embodiment, the user is directed to a buyer NDA page 32 to review and agree to a confidentiality agreement. In another embodiment, a buyer is not directed to the buyer NDA page 32 until such time as the buyer desires to review confidential information. Once the buyer is registered, the buyer then goes to a unique buyer home page 34 that displays information unique to that buyer. After a buyer has initially entered site 20, the buyer would be immediately directed to their buyer's home page 34 upon accessing the site via secured login 22. If the buyer wants to later update their profile at page 30 or review again the confidentiality agreement at page 32, the buyer can also access those pages at a later point from their home page 34. In one embodiment, an approved buyer would be provided with an initial period of time in which to try the site 20 without charge, after which the buyer would pay a periodic fee to continue to use the site. This periodic fee may be waived if a buyer is classified as a large corporate entity with a history of substantial acquisitions or if the buyer is valuable to the investment bank. In another embodiment, the buyer may arranges with the investment banking firm to be listed as a “selected buyer” on a page listing the names of significant buyers who are utilizing the site 20.

In a similar manner, a seller is initially directed to a seller registration/profile page 40 upon logging into the site 20. Preferably, the seller registration/profile page 40 allows for the opportunity to upload confidential information of the seller in an electronic format determined by the seller. Upon completing this page, the seller will be directed to a seller NDA page 42 to review and agree to a confidentiality agreement. Once a seller has registered and reviewed the NDA, the seller may optionally be provided with an opportunity to enter into a retainer agreement with the investment banking firm at page 44. Preferably, the investment banking firm is compensated for hosting the site and providing additional services to the seller by collecting a small percentage of the total value of any resulting merger or acquisition that is paid by the seller under the retainer agreement. In another embodiment, the NDA agreement and the retainer agreement may be accomplished as part of a single agreement on a single page. Once a seller has registered and has reviewed the NDA and, optionally, the retainer agreement, the seller then goes to a unique seller home page 46 that displays information unique to that seller. As with the buyer side, the seller can go back and update profile information, provide additional confidential information, review the NDA or review the retainer agreement had a later point from their home page 46.

A management program 26 is executed by the host computer 10 and interfaced with the site 20 to coordinate communications among registered sellers, registered buyers and the investment banking firm in response to actions at the site via the networked computer system 12. The management program 26 allows registered sellers to selectively control the transmission of confidential information of the registered seller to potential registered buyers. It also allows registered buyers to generate expressions of interest and offers for the businesses of registered sellers using the site as the communication medium for such actions. Preferably, the management program 26 is a C++ program that manages both the HTML pages for the site and a series of databases in which confidential information of buyers and sellers is maintained. The management program 26 also is connected to and coordinates with an e-mail access to generate e-mails to registered buyers and registered sellers advising them when updated information is available on their home pages 34, 46 or when action is required and the user must return their home page 34, 46. The management program 26 and identify matching opportunities in a number of ways. Preferably, an automated filtering technique is used to screen the information provided by buyers and sellers in their registration/profile page 30, 40 to identify buyers and sellers have overlapping indications. In one embodiment, the automated filtering technique is periodically run by the management program 26 can matching opportunities are automatically listed in the respective home pages 34, 46 of the registered buyers and registered sellers associated with the matching opportunities. In another embodiment, the automatic filtering technique is initiated by a user from the administration page 24. In this embodiment, the user representing the investment banking firm has opportunity to review, edit, add or delete matching opportunities before they are updated to the respective home pages 34, 46. Preferably, the matches are initially displayed to the seller at the seller's home page 46 and the seller has the ability to control the level of access that will be granted to each of the sellers identified as matching opportunities. In this embodiment, messages to the authorized buyers are generated after the seller has reviewed the list of opportunities. It will be understood that the seller may preapprove selected buyers so as to avoid the step of having to require the buyers to request access to different levels of executive summary of confidential information. Either of these techniques can be supplemented by matches separately identified by the user for the investment banking firm. Additional matching techniques such as collaborative filtering or neural network processing can be applied to the information to further enhance and refine the generation of matching opportunities. Preferably, a post transaction survey of both of the parties to a completed transaction is utilized to gather customer satisfaction and other preference feedback information that is then utilized as feedback data to refine the process of generating matching opportunities.

Although the overall site architecture has been described in FIG. 2, it will be recognized that numerous variations could be made within the scope of this invention. For example, the administration page 24 may be accessible by a separate site or by a separate login. A buyer agreement similar to the seller retainer may be added. It should be noted, however, that the site 20 has been developed to protect the confidentiality of both buyers and sellers. Unlike many existing sites, the present invention does not present a potential seller with the dilemma of either broadly disclosing confidential information in the form of a generally available classified advertisement in order to attract potential buyers or withholding such confidential information and thereby limit the amount of information that legitimate buyer might be able to review. By using both the NDA pages 32, 42 and the unique home pages 34 and 46 which display matches generated an managed by the administration page 24, the information of both buyers and sellers is protected and can be selectively disseminated under control the buyer and, particularly, the seller. This type of selective controlled release of confidential information is simply not available in the context of the classified advertisement format that is utilized in most matching sites today.

One of the objectives of the present invention is to significantly shorten the time frame required to complete a transaction, while at the same time broadening the potential audience for both buyers and sellers. The ability to effectively utilize the Internet as a communication medium for managing and ultimately concluding the transaction allows the investment banking firm to deliver greater value to sellers and buyers than a conventional investment banking firm. Initially, the target deal sizes that are most suited for utilizing the present invention are deals valued between $1 million to $100 million. Unlike web sites dedicated to providing funding for seed capital or startup stage companies, the present invention is designed to optimize communications for mergers and acquisitions of companies with some operating history and with stable or growing revenues or significant intellectual property or other intangible assets.

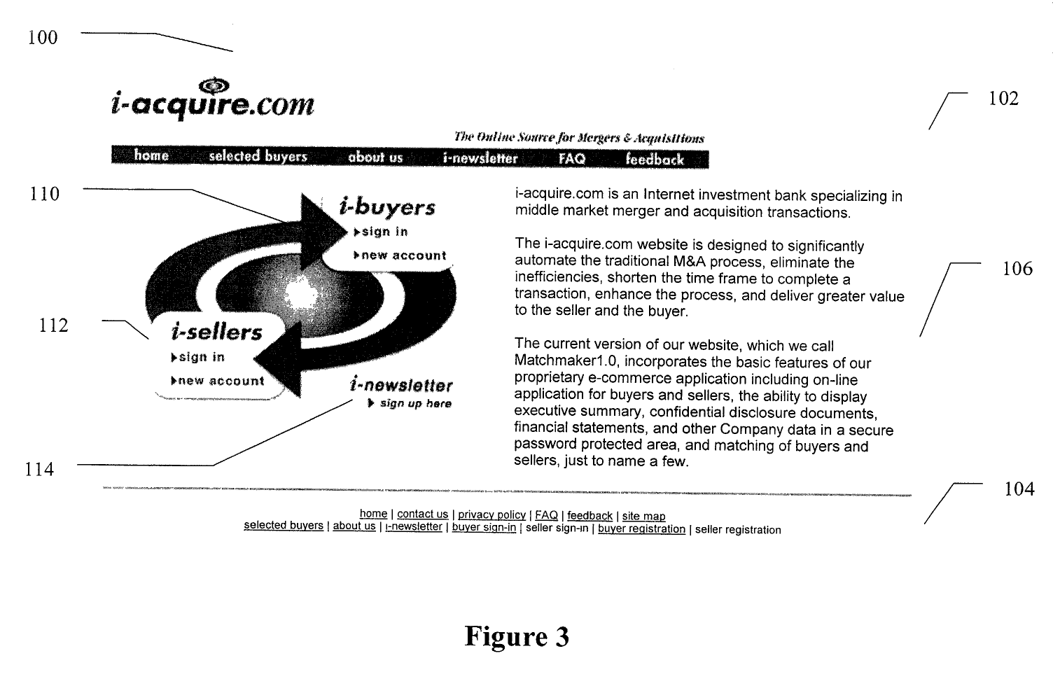

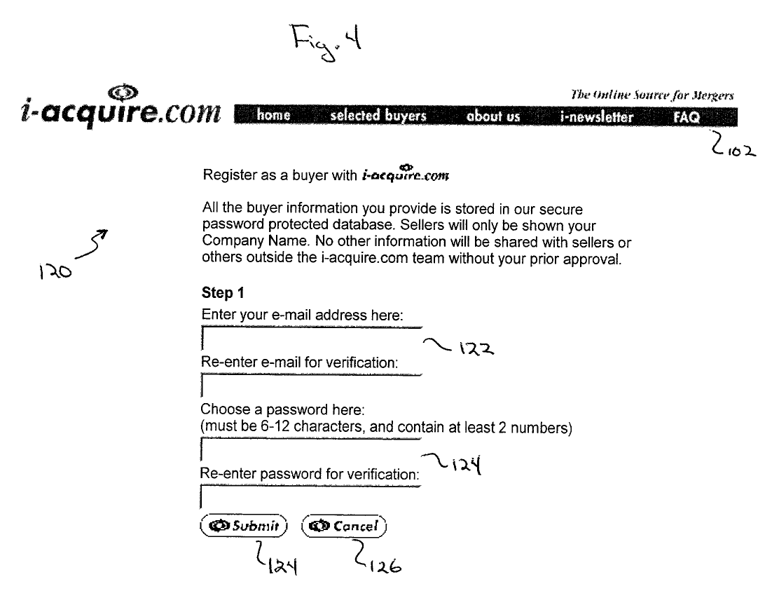

Referring now to FIG. 3, a detailed description of some of the screen shots of preferred embodiment of the site in accordance with present invention will now be described. FIG. 3 is a screen shot for a site home page 100. Preferably, all of the pages in the site 20 include a navigation bar 102 at the top of the page 100, and a set of navigation buttons 104 at the bottom of page 100 to aid users in navigating through the site 20. Text comments or help information 106 can be made available as part of the page structure as shown for site home page 100, or can be part of pull down menus or pop-up windows within a page. The site home page 100 has a section 110 that directs buyers to the buyer registration/profile page 30 or the buyer home page 34. A section 112 similarly directs sellers to the seller registration/profile page 40 or the seller home page 46. A section 114 optionally allows users to sign up for a newsletter distributed by e-mail to interested users.

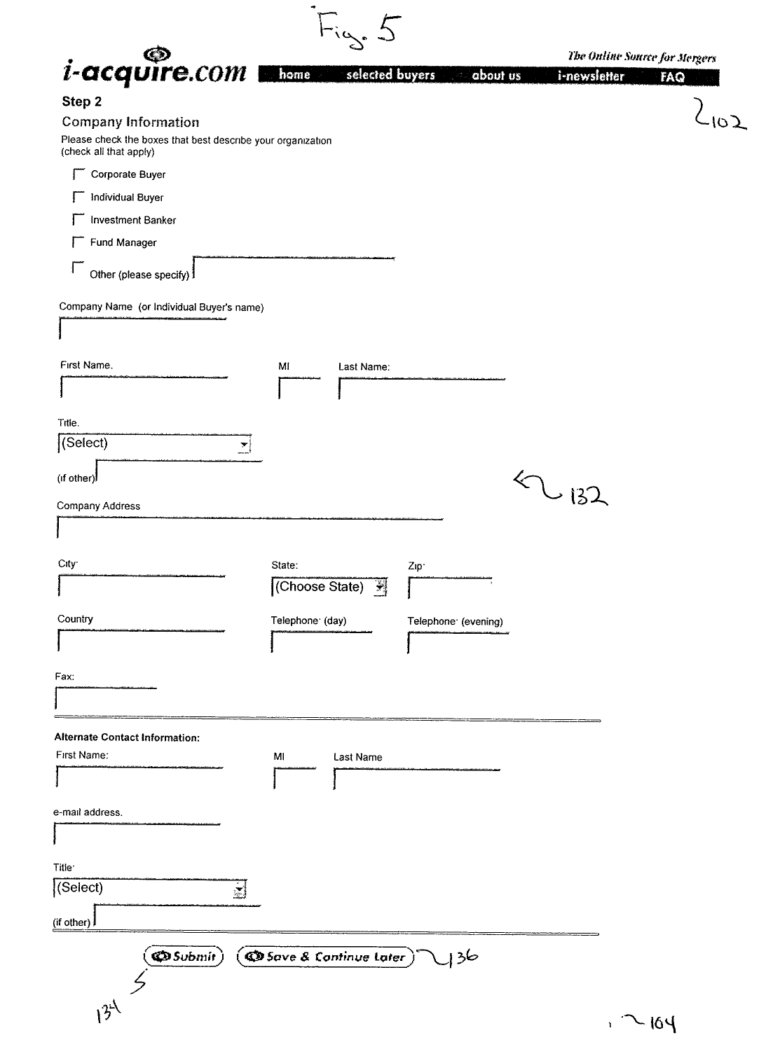

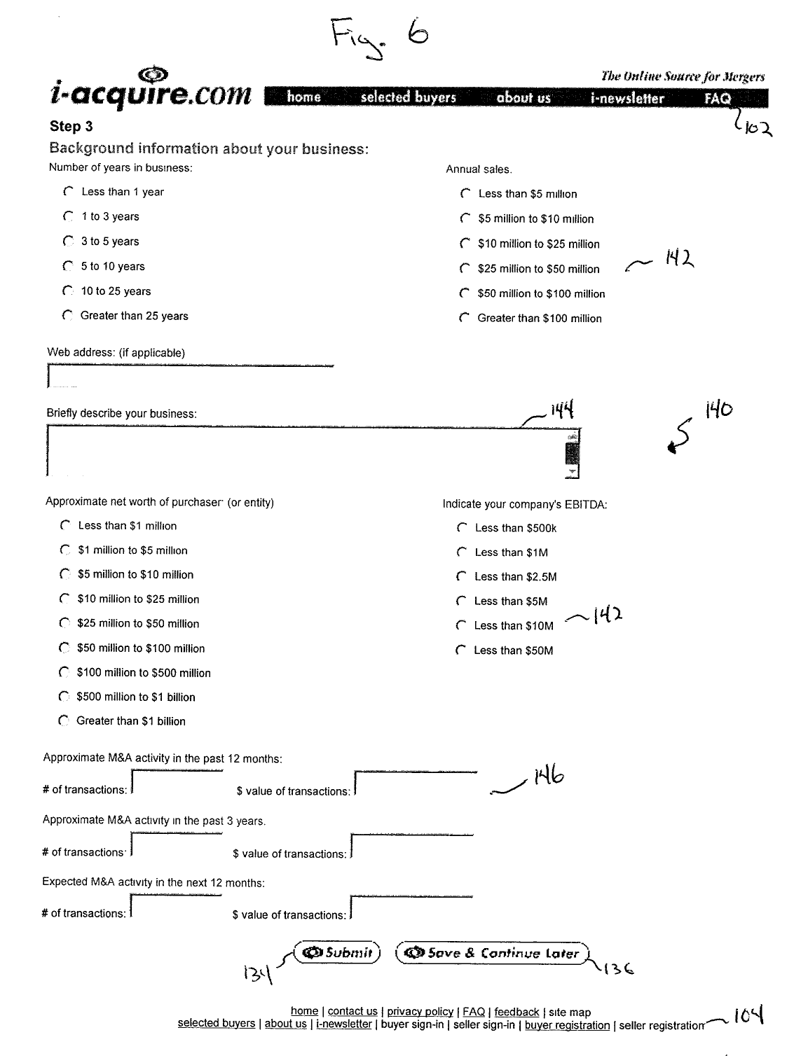

FIG. 4 shows page 120 which is referred to as Step 1 in the buyer registration process. In Step 1, a user enters their e-mail address as a logon identification 122 and then chooses a password 124. Preferably, these values are re-entered by the user for confirmation and to avoid misspellings and the like. It will be understood that use of the e-mail address is intended to allow communication with the user via this e-mail address. Alternatively, other forms of login identifiers could be used and one or more e-mail addresses could be collected as part of Step 2 described below. As with all of the other pages in the site 20, the navigation bar 102 and navigation buttons 104 are used to frame the page. A submit button 124 and a cancel button 126 are activated by the user to either submit the information as part of the registration process or cancel and exit the process.

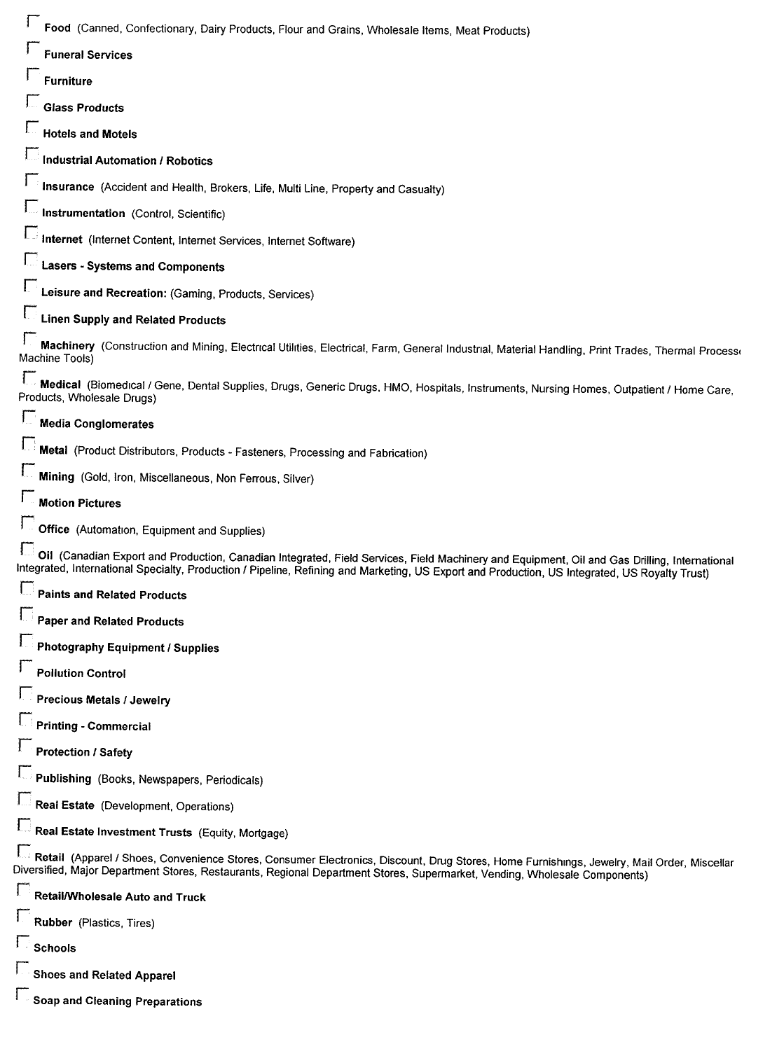

FIG. 5 shows page 130 which is referred to as Step 2 in the buyer registration process. In this step basic company information 132 is provided, such as name, contact name, address, telephone and fax number. Alternate contact information may also be collected. At page 130, the action buttons are submit 134 which submits the information and moves the user to the next step. Alternatively, save and continue later 136 will allow a user to mark their place in the buyer registration process to be automatically resumed at a later point when the user logs back into site 20. A user can also utilize the navigation buttons of their browser to move between pages without submitting the information to the site 20.

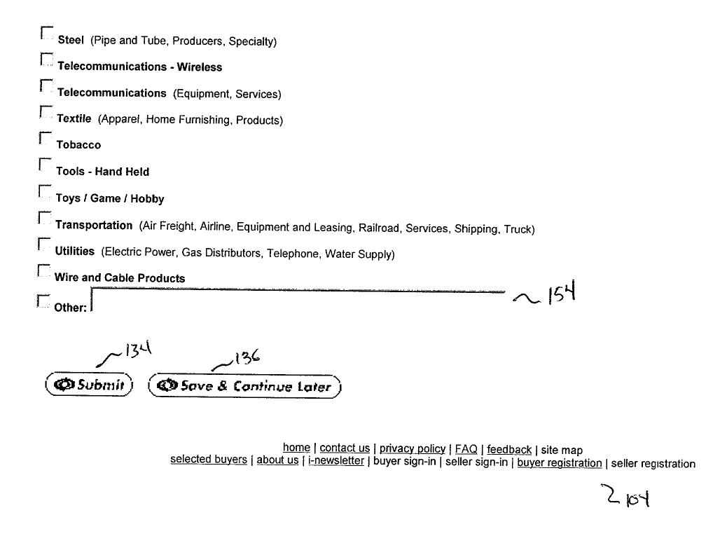

FIG. 6 shows a page 140 which is referred to as Step 3 in the buyer registration process. In this step background information 142 about the buyer is entered. To facilitate organization of this information into a database that can be accessed by the management program 26, the background information is preferably entered in a multiple choice format where the user selects among certain predefined choices. Optionally, a free text field 144 can also be used to describe the background information. Additionally, numeric entry fields 146 can also be provided where specific numeric information is being sought in response to predefined questions.

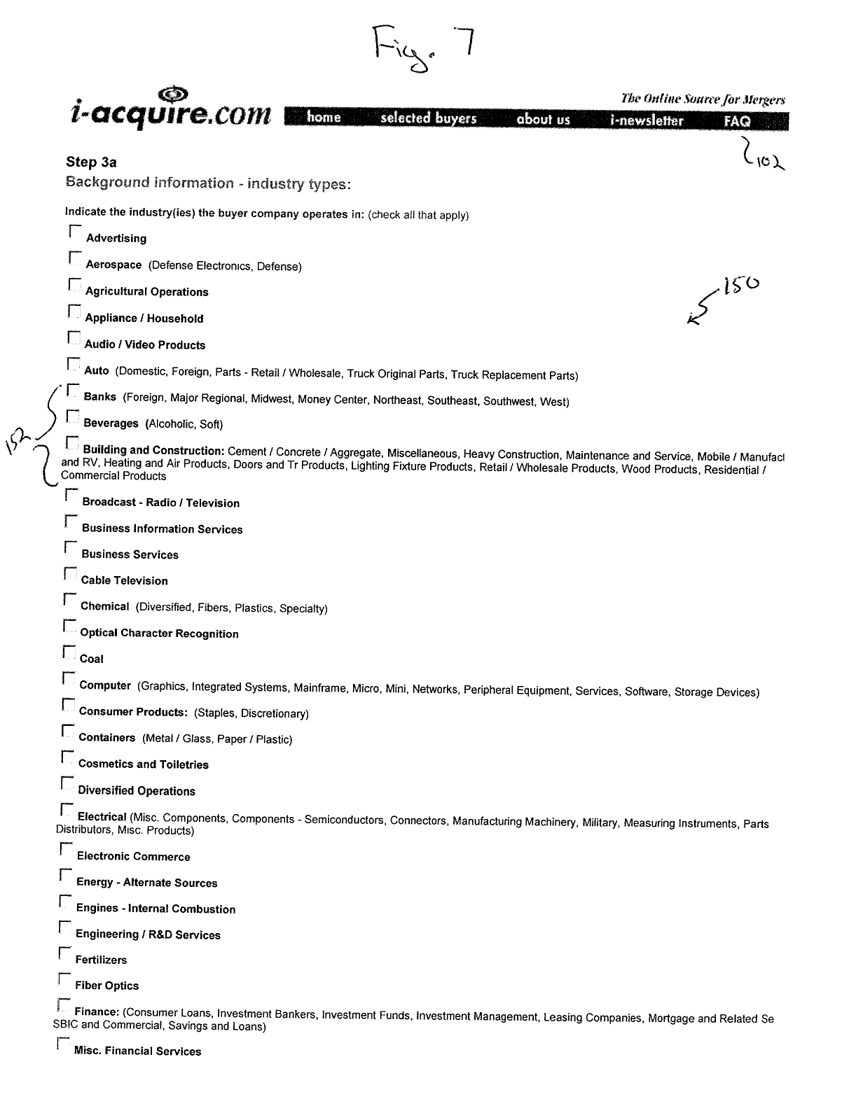

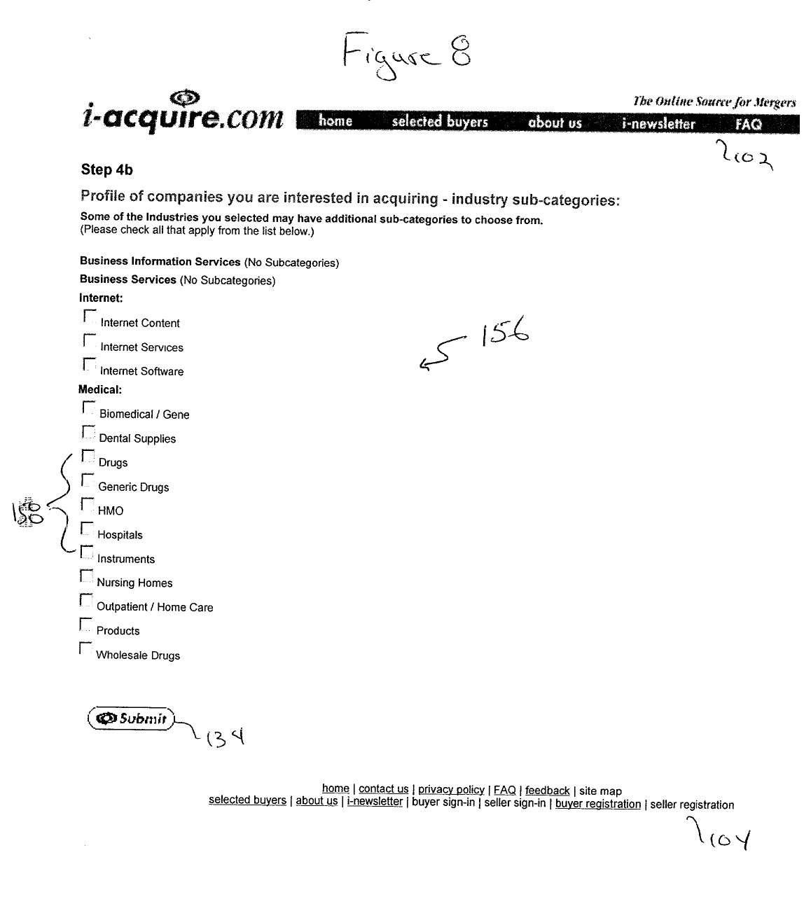

FIG. 7 shows a page 150 which is referred to as Step 3a in the buyer registration process. This page is a continuation of page 140 and allows a user to enter one or more choices of predefined industry types 152. The industry types 152 may be defined for the user or the user may identify one or more other industry types as provided for in data entry field 154. Alternatively, the industry types 152 may be numeric or alpha-numeric codes of industry types according to any of a number of known categories. The industry types in page 150 are for the industry(s) where the buyer operates. Alternatively, the industry types 152 could be used to identify industry(s) a buyer is interested in or in which the buyer has previously made a merger or acquisition.

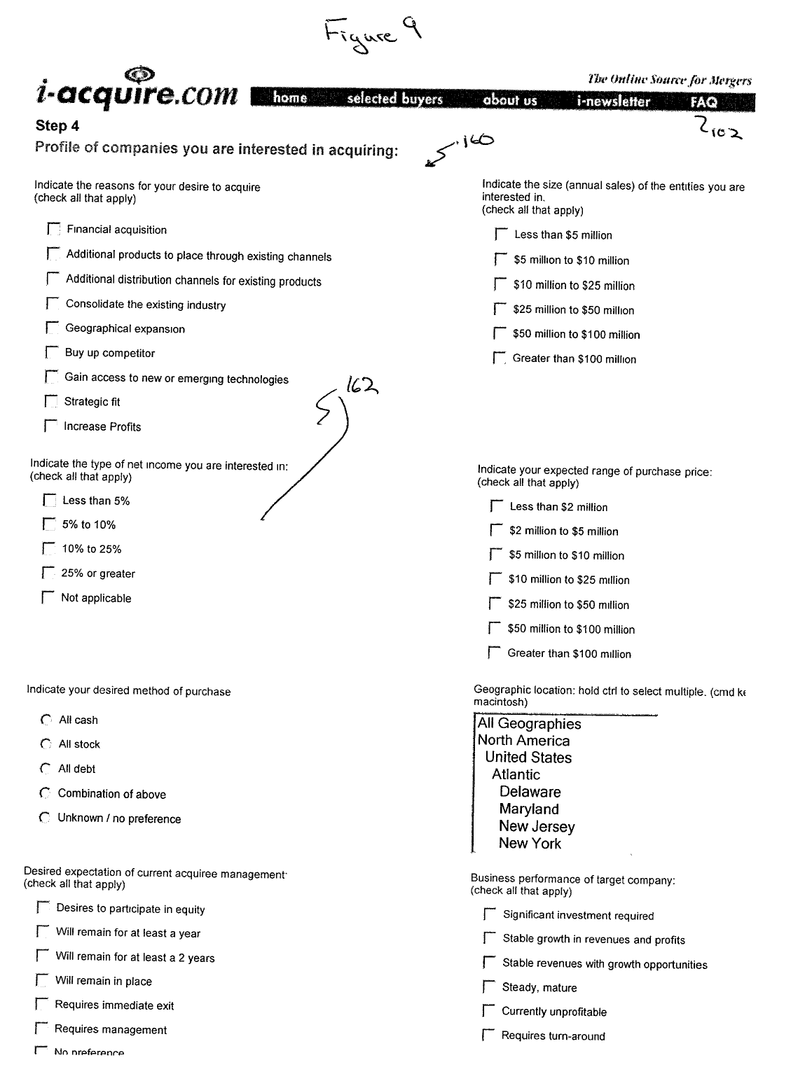

FIG. 8 shows a page 156 that is referred to as Step 3a in the buyer registration process and is an optional expansion of page 150 in which predefined subcategories 158 for the selected industry types 152 are displayed and a user may optionally refine the identification of their areas of experience and/or interest.

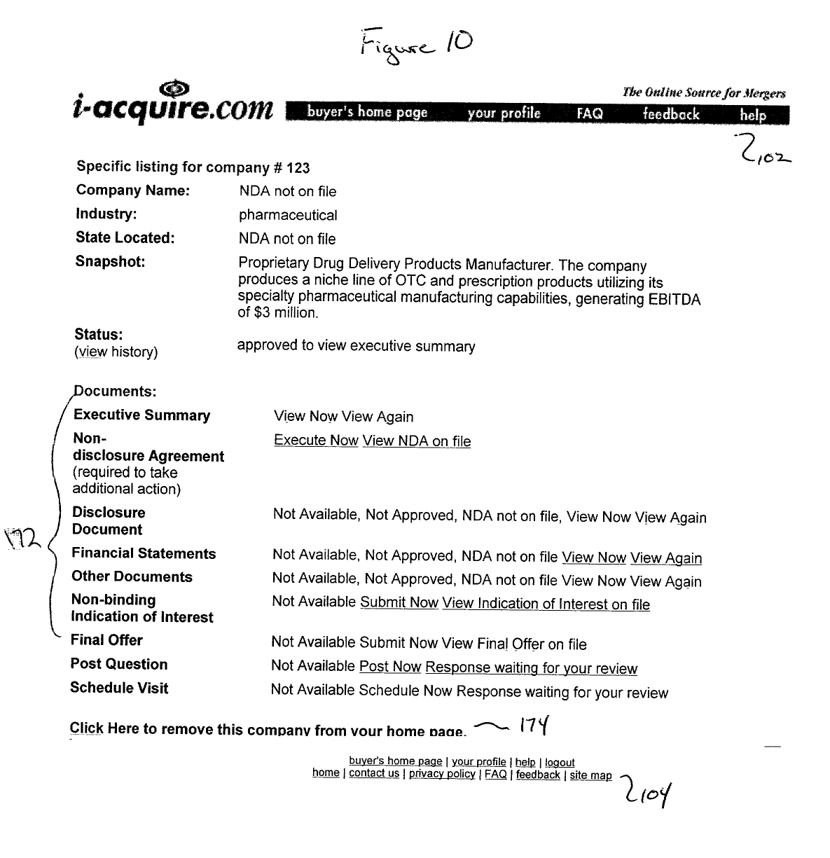

FIG. 9 shows a page 160 that is referred to as Step 4 in the buyer registration process. In this page, the user indicates those qualities of a business opportunity that are of interest to the buyer. Multiple multiple choice selections 162 preferably are used to segregate potential opportunities based on motivational, economic and geographic criteria for a desired opportunity. A free text area 164 is provided for a text entry description of desired opportunities. Keyword area 166 may be utilized as part of the automated matching performed by management program 26 to further enhance matching above the matching based on database matching of multiple choice selections 162. A cross-referral area 168 can also be used to further refine searching based on similar historical matches. The utility of cross-referral area 168 will increase over time as more transactions are recorded in the databases accessed by management program 26 that can serve as confidential historical templates. Preferably, a Step 4a and Step 4b present the identification of industry categories 152 which are of interest in a manner similar to Step 3a and Step 3b as shown in FIGS. 7 and 8.

Once Steps 1-4 have been completed, the user is presented with the information that has been entered in a confirmation page at Step 5. The confirmation page can either allow the user to directly modify information on that page or can direct the user back to the original entry page for any modifications of the information that may be required. Otherwise, the user confirms that the information entered is correct and the buyer registration/profile page 30 is completed. In one embodiment, the user is then directed to the buyer NDA page 32.

Preferably, the buyer NDA page 32 includes a nondisclosure agreement that is presented user as a standard form agreement that is intended to cover all of the information they may review at the site 20. In one embodiment, the user has the option of agreeing to the standard form, editing the standard form and placing the modified NDA into a database to be viewed by registered sellers, or submitting their own NDA which would be placed into a database to be viewed by registered sellers. It should be noted that if a user does not agree to the form NDA agreement or provide an alternative replacement, they will not be allowed access to confidential seller information. In one embodiment, the user for the investment bank has the ability to control whether buyers will be permitted to modify the NDA agreement and, if so, at what level modifications may be acceptable. Optionally, a user can be directed to the buyer NDA page 32 each time they enter the site to reinforce the obligation of confidentiality imposed by this agreement.

The buyer home page 34 presents a unique listing of all of the opportunities which are determined by the management program 26 to match the buyer profile information for that particular buyer. Preferably, these opportunities are not displayed until the matching opportunities have been reviewed and approved by the seller. In one embodiment, the buyer home page 34 would list in tabular format the industry for a matching opportunity, the most current annual revenues, the date the opportunity was added on the site 20, the home state for the opportunity, a nonconfidential snapshot or summary of the opportunity written so as not to disclose the identity of the seller associated with this opportunity. Optionally, the buyer may be also advised of the present status of negotiations relative to this opportunity. Preferably, the home page 34 is customizable such that the buyer can display opportunities sorted by date, industry, location, revenues or status. Depending upon the degree of confidentiality requested by the seller, it is also possible to block the display of one or more of these categories of information about the opportunity until such time as the buyer executes a confidentiality agreement at buyer NDA page 32.

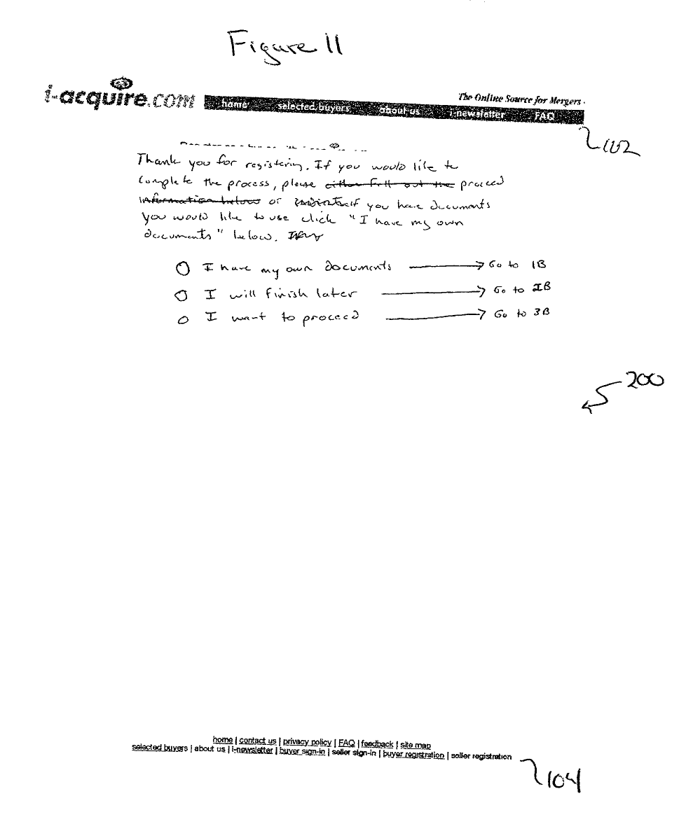

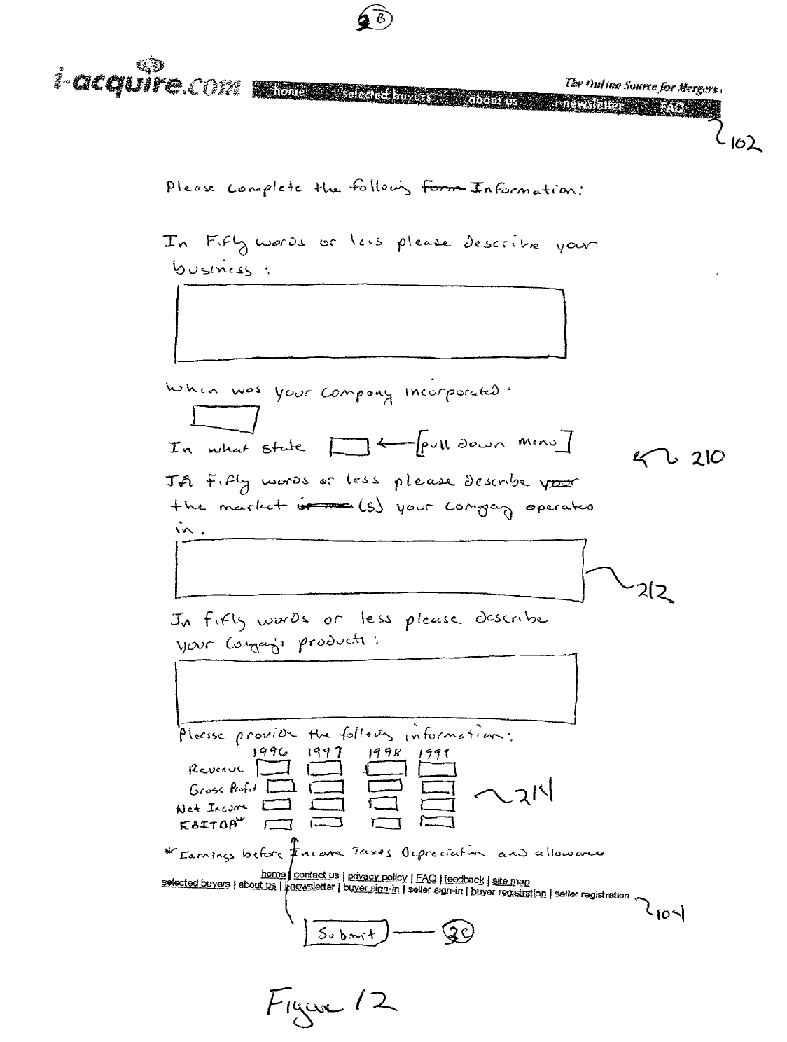

FIG. 10 shows a screen shot for the specific listing page 170 to that can be accessed for each of the opportunities identified on buyer home page 34. In a preferred embodiment, the buyer would access specific listing page 170 by double-clicking on the display for that opportunity in the buyer home page 34. In addition to the categories of information that are shown on the home page 34, the specific listing page 170 preferably list the company name and control buttons associated with a series of document review and actions steps 172. A button 174 for removing the company from listing on the buyer's home page 34 is also provided. Preferably, the buyer is prompted to provide an explanation of why they are removing a particular company from the listing. This information can be used to heuristically improve the matching process in the future.

If a buyer wishes to review the executive summary for a given opportunity and has not been preapproved by the seller to review it, the buyer would receive a message that their request to review the executive summary has been submitted to the seller and that they will be notified by email to return to the site 20 when the seller approves this request. Simultaneously, the management program 26 generates an email that is sent to the seller indicating that the seller should return to the site to approve or block the request for an executive summary to be reviewed by a buyer. Once the seller has logged into the site 20, the seller home page 46 would display the identity of the buyer requesting the executive summary to allow the seller to take appropriate action to approve or block this request. As with all the other email notification functions performed by the management program 26, it is preferred that the management program 26 keep a diary and calendar of these communications such that reminder emails and default actions can be taken after the passage of certain periods of time. For example, if a given number of days has passed without a response from the seller to request for executive summary's or other documents are confidential information, the management program 26 can begin generating emails to the user for the investment bank to contact the particular seller to determine the reason for the delay. If two weeks, for example, have passed without appropriate action being taken, the buyer would be notified that due to lack a response by the seller, the buyer's access to the requested information has been denied. Once the seller has approved the buyer's request to review the executive summary if it has not previously approved, the manager program 26 sends an email to the buyer indicating that their request to view the executive summary for given opportunity has been approved and providing a link which they may access to get back into the site. In the event of the seller blocks the buyer's request to review the executive summary, the seller is required to identify a reason for this action and that reason is communicated to the buyer. In one embodiment, the buyer is provided with the ability to respond to this rejection and describe why the buyer should be allowed access to the executive summary.

Upon reviewing the executive summary, the buyer is preferably provided with three options to (a) proceed with review of the complete disclosure document for the opportunity, (b) express an indication of no interest in the opportunity and delete it from the buyer's home page 32, or (c) place the opportunity in a pending status subject to further review by the buyer. Assuming that the buyer has executed an appropriate NDA agreement, if the buyer wants to proceed with review the next step is for the buyer to review the disclosure documents for this opportunity. A similar procedure is followed for requesting access to the complete disclosure document as was done for requesting access to the executive summary. In this way, the seller controls the gradual and managed release of confidential information relating to the opportunity to different buyers in response to their indications of interest in the opportunity. The materials which represent the disclosure documents for the opportunity have been created as will be described in connection with the seller's home page 46. In addition to the complete disclosure document, the buyer is provided with an opportunity to review financial statements and other documents. As part of a process of reviewing other documents, the buyer may also transmit a message to the seller for request for additional information as part of this review.

Once the buyer has completed the process of reviewing the disclosure document, the financial materials and any other documents, the buyer is prompted with three options. The buyer may indicate that they: (a) want to express an non-binding indication of interest, (b) to are interested in proceeding and submitting a letter of intent, (c) are not interested in proceeding, or (d) want to place the opportunity in a pending status subject to further review. In the last option, the buyer is preferably allowed to have reminder emails generated for this pending opportunity. Again, the management program 26 manages email communications between the buyer and seller and appropriately updates the status of each of their respective home pages 32, 46 to reflect these choices.

If the buyer wants to express a non-binding indication of interest, this indication is communicated by the management program 26 to the seller. Preferably, a standardized non-binding indication of interest is generated based on the company name with appropriate fields to be completed indicating a general range of the financial and other significant terms contemplated by the indication of interest. Optionally, the user may enter additional information in a free text area or may submit an attachment containing the terms of the non-binding indication of interest. In the event that the seller has established a timetable for submission of letters of intent, the management program 26 will automatically send email notices to buyers who expressed in indication of interest concerning the nature of such a timetable and encouraging the buyer to return to the buyer's home page to review the opportunity and submit a letter of intent if so desired.

If the buyer has indicated that they are interested in submitting a letter of intent, an online form containing various standard paragraphs consistent with the interest expressed by the buyer are displayed for the buyer to add and edit. For some paragraphs, the online form may contain blanks such as values or number of shares that need to be completed. For other paragraphs, the online form may be provided with free text entry areas. In this case, the user may cut and paste material developed offline into the free text entry area, enter text directly into the free text area, or may use any combination of these together with editing entered text. Optionally, the buyer may be provided with an opportunity to digitally sign the letter of intent once completed. Alternatively, the buyer may also be provided with an opportunity to format the completed letter of intent on the buyer's letterhead and/or provide a graphic image of an authorized signature. As with the non-binding indication of interest, the buyer may also submit an attachment containing the letter of intent. Once the letter of intent is acceptable to the buyer, the buyer would submit a letter of intent and the management program 26 confirms submission of the letter of intent and advises the buyer that they will be notified by email if the seller selects them or selects them as a finalist among the group of finalist. In the event that a buyer is selected as a finalist by the seller, the seller preferably can indicate to all finalist certain terms or considerations which are of importance to the seller in evaluating the firm offers of all finalist, as well as a specific timetable for when a final decision will be made. Optionally, the buyer may be allowed to modify or change their letter of intent at any time after the letter of intent has been submitted by returning to the buyer's home page 32.

Buyers who have submitted a letter of intent are also allowed to request that a visit to the seller be scheduled. The management program 26 preferably coordinates visits among multiple buyers in accordance with a calendar schedule of availability established by the seller.

Buyers may also at any time be provided with an opportunity to request additional information or ask specific questions of a seller. In this case, the management program 26 coordinates the questions and answers via email and the buyer and seller's home pages 32, 46. Preferably, the seller is permitted to indicate whether a buyers question and the answer to that question are to be made available to all buyers or only to the specific buyer asking that question.

Once a seller has accepted a letter of intent from a given buyer, the management program 26 update the buyer's home page 32 for all of the buyers for which the seller is listed on their home page 32 indicating that a deal is now pending for this opportunity. In the event that negotiations subsequent to the acceptance of the letter of intent breakdown, the seller may reopen the process, in which case the management program 26 would update the listings. Optionally, to the management program could also send email notices to all potential buyers who had removed this opportunity from their home page advising them that the opportunity was again available.

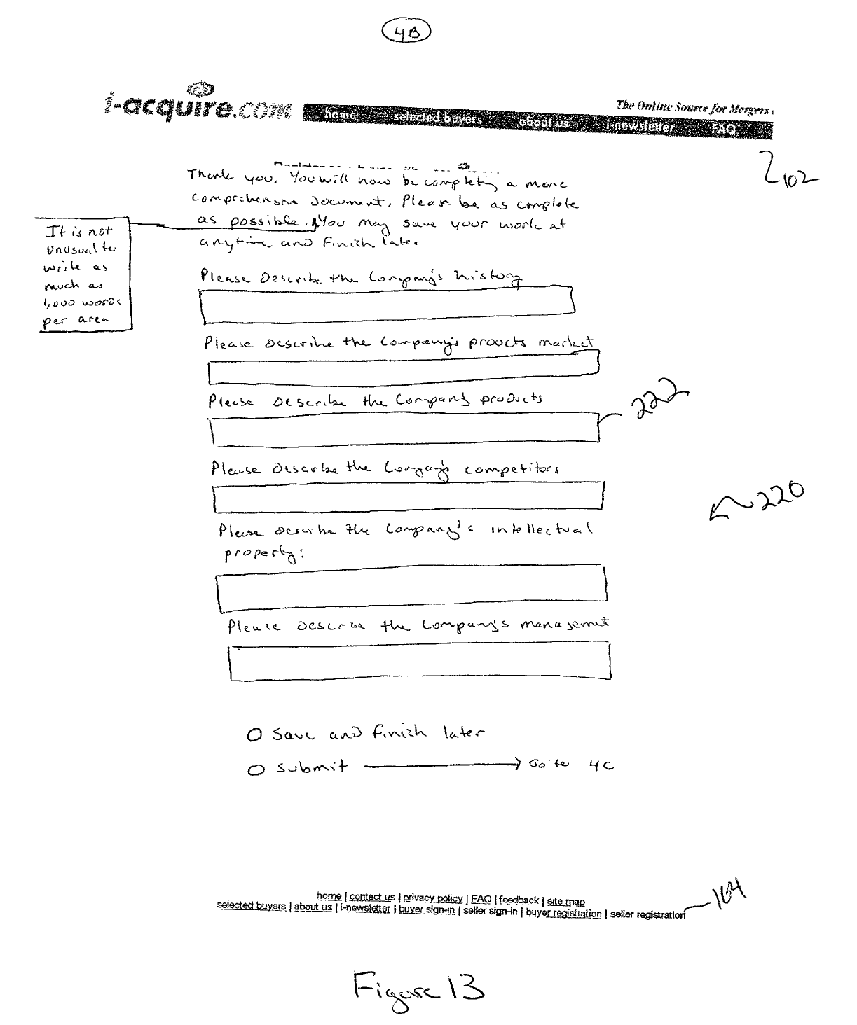

Referring now to FIGS. 11-, the process of generating the complete disclosure documents will be described in further detail. FIG. 11 shows a page 200 that allows a potential seller to begin the process of providing information for the complete disclosure documents. In the event that a seller has already generated documents for this purpose, the seller is allowed to directly upload these documents to the site 20. Preferably, the user will provide this information in one of a defined set of acceptable document formats. Optionally, this information can be made available directly without further review, or the information can be reviewed by a user for the investment bank, depending upon the terms of the retainer agreement executed with the seller.

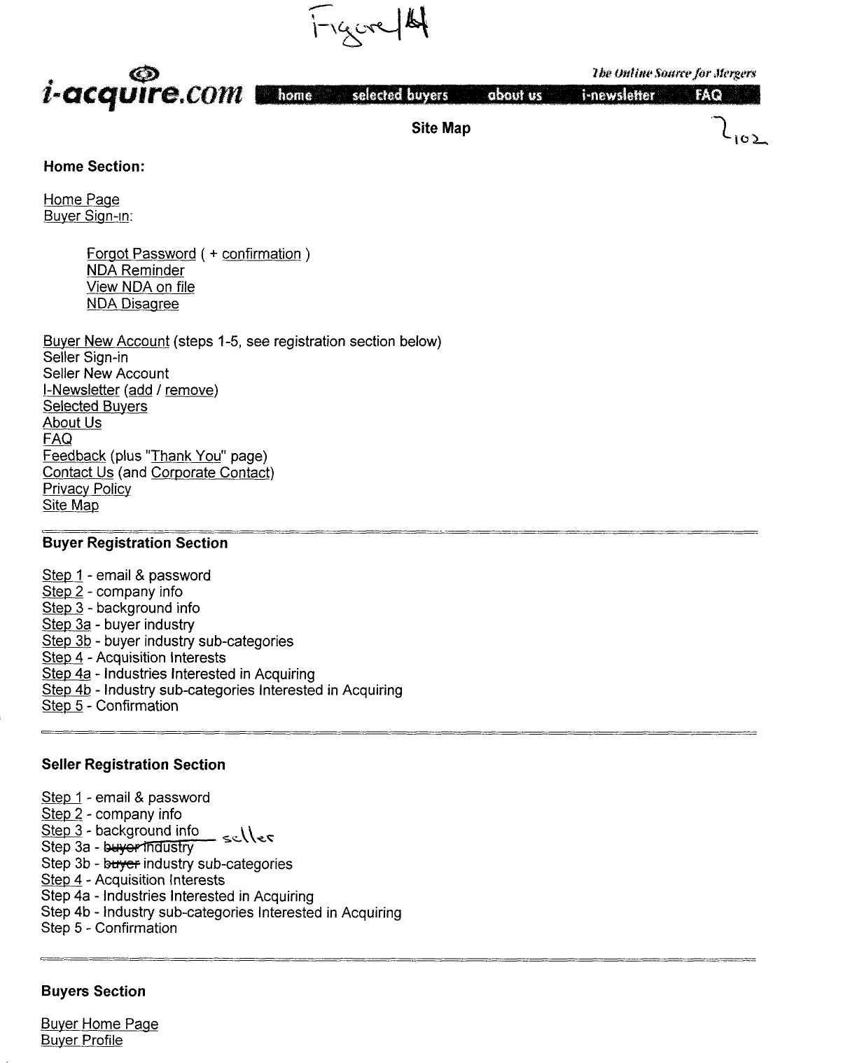

FIG. 12 shows a page 210 that is used to collect information for the executive summary. Preferably, this page includes free text entry areas 212 with a limited number of words that may be entered, as well as historical financial data values 214 that are to be completed. Once information has been entered, the seller may review this information in the format will be presented to buyers and make any further corrections, additions or changes as desired. It should be noted that the management program 26 combines information entered on page 210 with previous information of the seller concerning this opportunity that has been entered on the seller's registration/profile page 42. Optionally, the seller may also be prompted to enter a nonconfidential snapshot summary that will be displayed on a buyer's home page 32 if a match is indicated by the system. Alternatively, the nonconfidential snapshot summary may be prepared by a user for the investment bank.

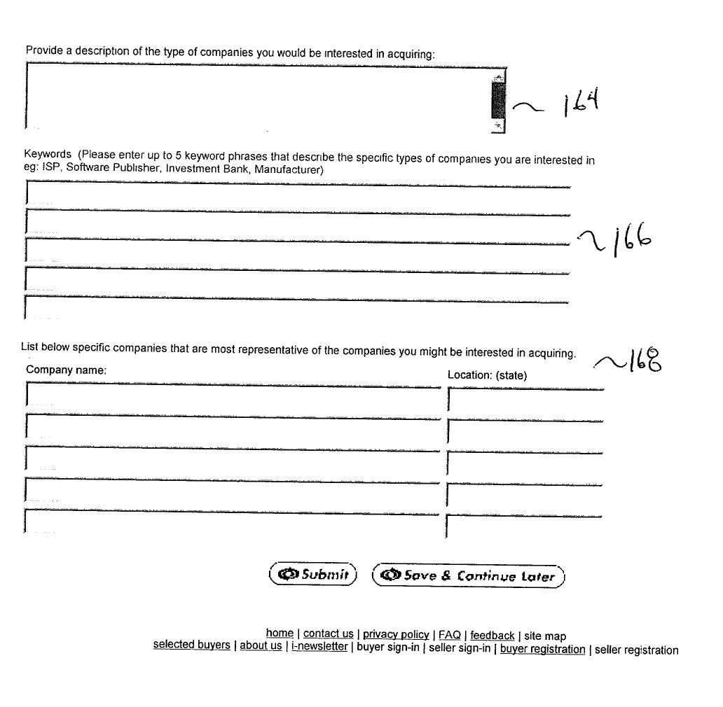

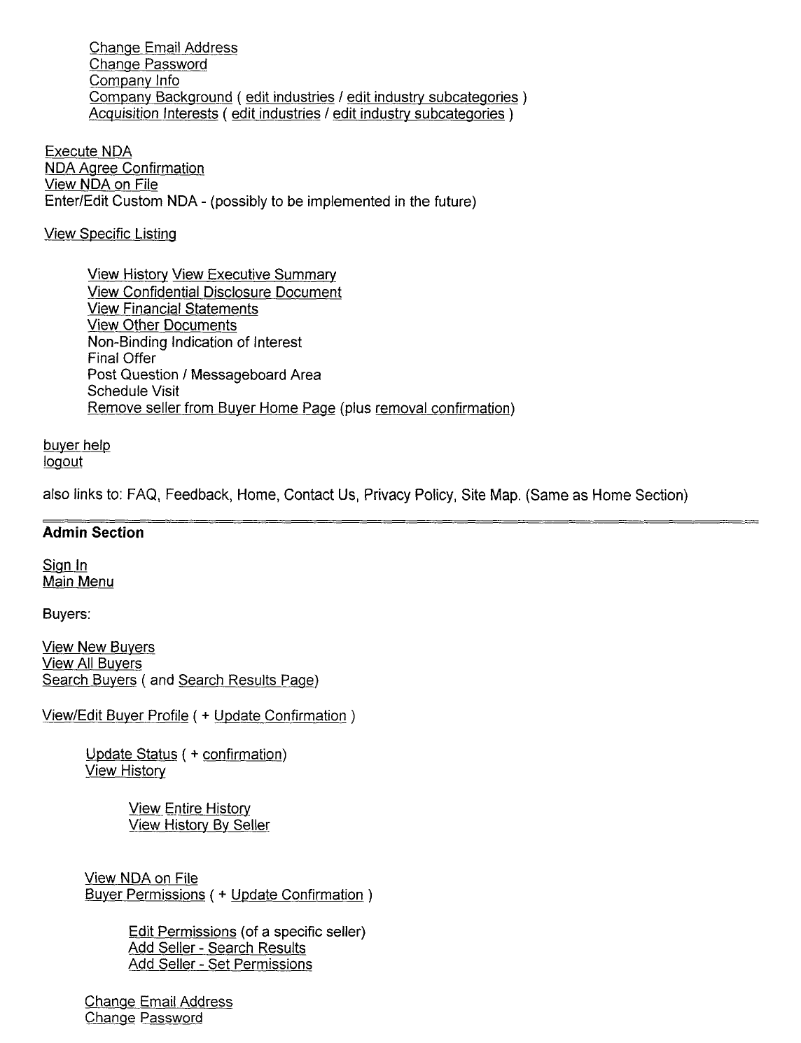

FIG. 13 shows a page 220 that is used to collect information for the complete disclosure document. Unlike the executive summary where the free text areas are limited to define number of words, the seller in page 220 is encouraged to provide as much detailed information as possible concerning the nature of the opportunity in a number of free text areas 222. Due to the potential of the nature of the input of this information, the seller is provided with the ability to save their progress to be continued in the later point in time. Optionally, the seller may be provided with help screens showing examples of how a particular section of the complete disclosure document may be written. Depending upon the nature of the retainer agreement executed with seller, a user for the investment bank may assist in the writing and/or editing of the various sections of the complete disclosure document.

In addition to the textual information entered on page 220, the seller is preferably provided with an opportunity to upload related text and graphic images, such as product brochures or manuals, or provide links to nonconfidential materials contained on the seller's web site or on the web site of the third party, such as SEC filings on the Edgar web site. The seller is also preferably provided with an opportunity to upload financial documentation in a standard spreadsheet format or in one of the pre-defined set of accounting or financial package outputs. In managing access to this uploaded information, the management program 26 keeps track of the format for each of the uploaded documents and will present buyers with an opportunity to review the same information in a more common format in the event that the buyer does not have the necessary software to view the information in its native format.

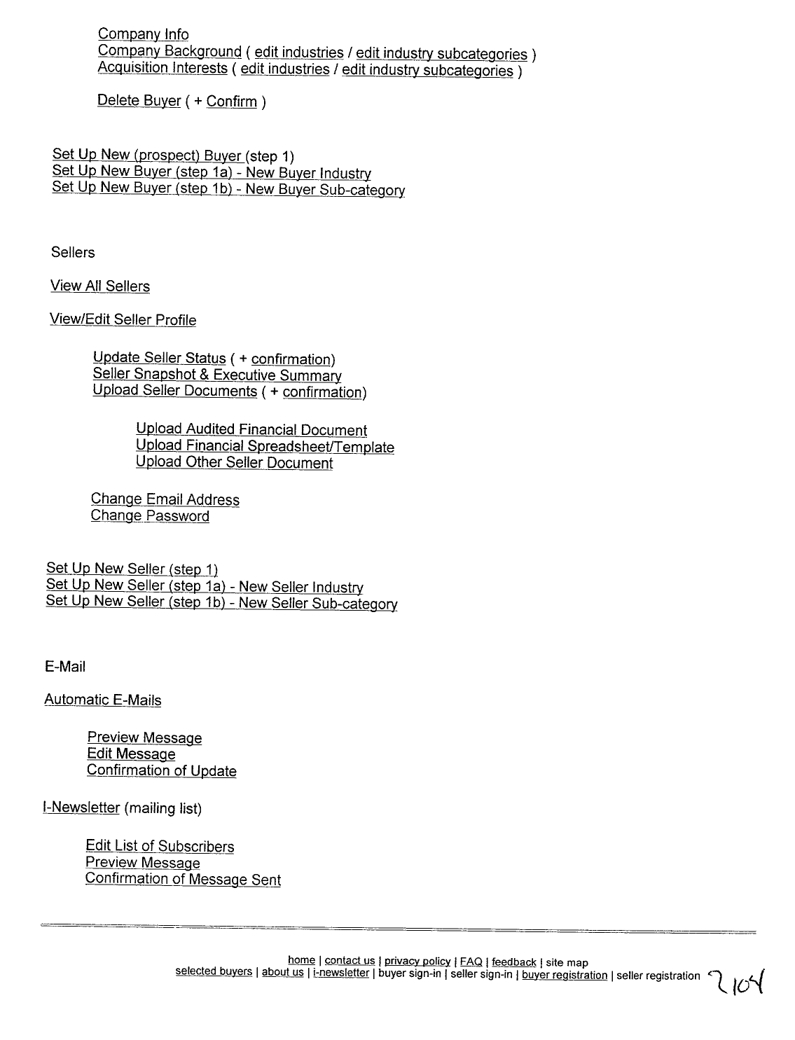

FIG. 14 shows a screen shot of the site map for one embodiment of the site 20 of the present invention. It will be recognized the various alternate options may be presented as part of the site 20 and still be within the scope of present invention. For example, the site 20 may also include a section where finders could register. As with registration buyers and sellers, this process would be automated. In the event that a finder registered and indicated a referral of either a buyer or seller to the site 20, and a deal in full them that buyer or seller was completed in which the buyer or seller indicated that the finder should receive a fee, then a finder's fee may be paid pursuant to the terms of the retainer agreement with seller to that finder.

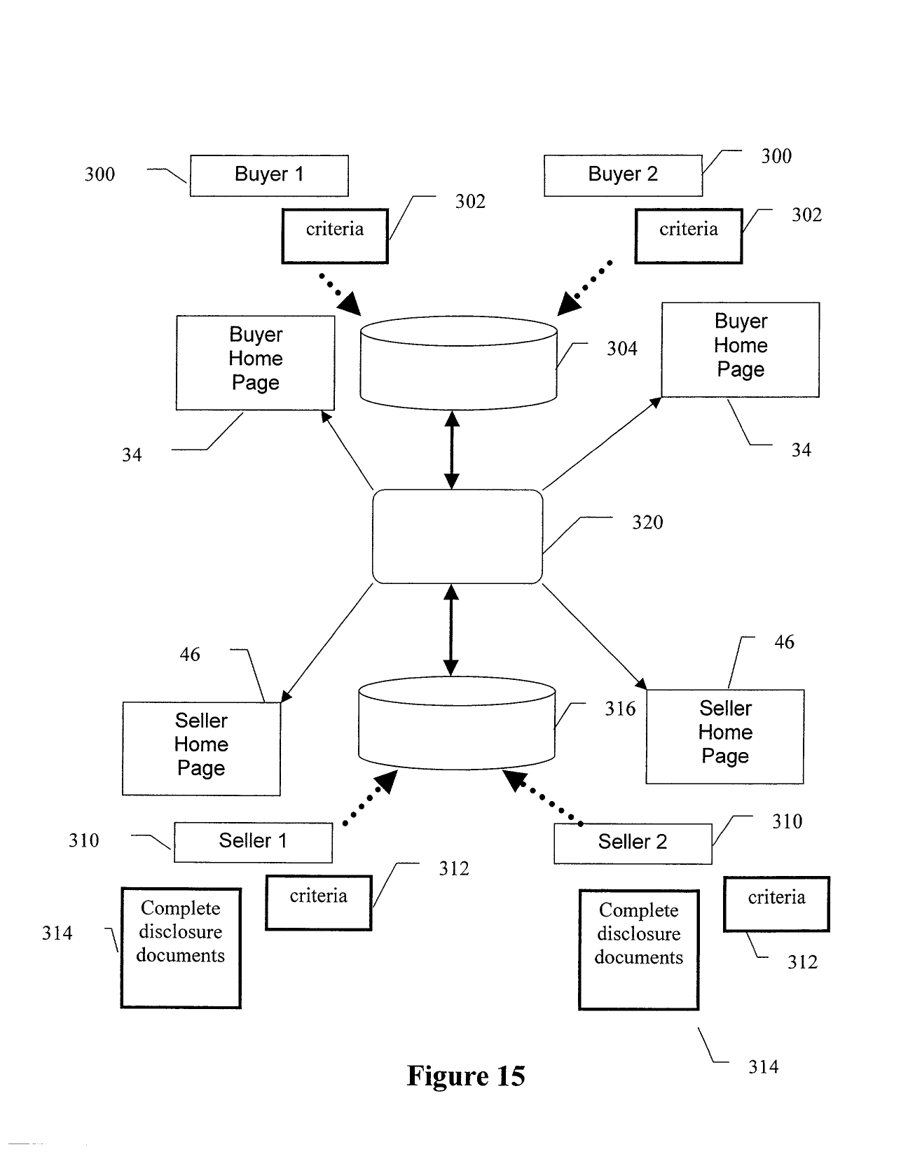

FIG. 15 shows a block diagram of the various databases use by the management program 26 to accomplish the matching function. Buyers 300 enter their respective criteria 302 which is maintained in a database 304 on the site 20. Similarly, sellers 310 enter their respective criteria 312 and also enter their complete disclosure documents 314. The criteria 312 are maintained on a seller database 316 on the site 20. The complete disclosure documents 314 are preferably maintained on separate file system with appropriate fire wall protection and no external links in order to prevent unauthorized access to this information. Preferably, the management program 26 is a java program 320 based on servlets which periodically access data bases 304 and 316 to generate relevancy rates of matching criteria maintained in these database weighted on preselected values for different types of information in the databases 304 and 316. Once a relevancy rate above a predefined value is found, the java program updates the seller home page 46 in response to the match to allow the seller the opportunity to review and approve selected buyers which are then notified of the existence of a match opportuntiy. As previously indicated, in a preferred embodiment, the user for the investment bank has an opportunity to add, edit or delete matches prior to the point at which the java program 320 would update the respective home pages 34, 46.

A portion of the disclosure of this invention is subject to copyright protection. The copyright owner permits the facsimile reproduction of the disclosure of this invention as it appears in the Patent and Trademark Office files or records, but otherwise reserves all copyright rights.

Although the preferred embodiment of the automated system of the present invention has been described, it will be recognized that numerous changes and variations can be made and that the scope of the present invention is to be defined by the claims.

1. An automated system for initiating and managing mergers and acquisitions of businesses between third parties utilizing a networked computer system comprising:
a host computer system operably connected to the networked computer system;
a site hosted by the host computer system and operated on behalf of an investment banking firm wherein the site is accessible to potential third party buyers and sellers via the networked computer system and comprises:
a secured login area where users login to the site;
a seller registration area where a user enters information for a seller profile and is registered as a registered seller and where the registered seller provides detailed confidential information about a business to be offered for sale in addition to the seller profile;
a unique seller home page area for each registered seller where information and communications relating to opportunities matching the seller profile for that registered seller are displayed;
a buyer registration area where a user enters information for a buyer profile and registers as a registered buyer;
a unique buyer home page area for each registered buyer where information and communications relating to opportunities matching the buyer profile for that registered buyer are displayed; and
a secure administration area where a user for the investment banking firm tracks initiation and management of matching opportunities and information and communications among registered sellers and registered buyers; and
a management program operably executed by the host computer and interfaced with the site that coordinates communications among registered sellers, registered buyers and the investment banking firm in response to actions at the site via the networked computer system whereby registered sellers selectively control the transmission of confidential information of the registered seller to potential registered buyers and registered buyers generate expressions. of interest and offers for the businesses of registered sellers using the site as the communication medium for such actions.

2. The automated system of claim 1 wherein the site further comprises:
a confidentiality area that is used to establish a confidential relationship between a registered seller and a registered buyer to protect the confidentiality of information exchanged between the registered buyer and the registered seller via the automated system.

3. The automated system of claim 1 the site further comprises:
a seller retainer area where a registered seller enters into a retainer agreement with the investment banking firm prior to the offering of the business for sale on the site.

4. The automated system of claim 1 wherein the administration area allows the user for the investment banking firm to add, edit or delete matching opportunities before they are displayed in the home page areas.

5. The automated system of claim 1 wherein the administration area allows the user for the investment banking firm to screen users based on their profiles and approve or deny a user as a registered buyer or a registered seller.

6. The automated system of claim 1 wherein the seller home page area allows the registered seller to upload confidential information of the seller in an electronic format determined by the registered seller.

7. The automated system of claim 1 wherein the buyer home page area comprises a non-confidential listing of opportunities matching the buyer profile for that registered buyer;
a button to request a confidential executive summary for a selected one of the listed opportunities;
a button to request additional confidential information for a selected one of the listed opportunities;
a button to generate a non-binding indication of interest for a selected one of the listed opportunities;
a button to generate questions of the registered buyer for a selected one of the listed opportunities;
a button to generate a binding final offer for a selected one of the listed opportunities; and
a button to remove a selected one of the listed opportunities from further consideration by removing the selected opportunity from the non-confidential listing of opportunities.

8. The automated system of claim 1 wherein the seller home page area comprises a non-confidential listing of opportunities matching the seller profile for that registered seller;
a button to provide a confidential executive summary for a selected one of the listed opportunities;
a button to provide additional confidential information for a selected one of the listed opportunities;
a button to review a non-binding indication of interest for a selected one of the listed opportunities;
a button to respond to questions of a registered buyer for a selected one of the listed opportunities;
a button to review a binding final offer for a selected one of the listed opportunities; and
a button to remove a selected one of the listed opportunities from further consideration by removing the selected opportunity from the non-confidential listing of opportunities.

9. The automated system of claim 1 the investment banking firm is compensated for hosting the site by collecting a small percentage of the total value of any resulting merger or acquisition that is paid by the seller.

10. The automated system of claim 1 wherein a registered buyer is proved with an initial period of time in which to try the site without charge, after which the management program charges the buyer a periodic fee to continue to use the site unless the buyer has completed a transaction on the site or the buyer arranges with the investment banking firm to be listed on a selected buyer page hosted by the site.
